(19) United States
(12) Patent Application Publication
(10) Pub. No.: US 2026/0135746 A1
(43) Pub. Date: May 14, 2026

(54) ADAPTIVE REFERENCE SIGNAL SIGNALING

(71) Applicant: QUALCOMM Incorporated, San Diego, CA (US)

(72) Inventors: Kexin XIAO, Shanghai (CN); Hung Dinh LY, San Diego, CA (US); Huilin XU, Temecula, CA (US)

(21) Appl. No.: 18/706,166

(22) PCT Filed: Jan. 14, 2022
(86) PCT No.: PCT/CN2022/071939

§ 371 Date: Apr. 30, 2024

(51) Int. Cl. H04L 27/26; H04W 68/02; H04W 72/232

(52) U.S. Cl. CPC H04L 27/261; H04L 27/2607; H04W 68/02; H04W 72/232

(57) ABSTRACT

Various aspects of the present disclosure generally relate to wireless communication. In some aspects, a mobile station may receive reference signal adaptation information or reference signal availability information for a radio resource control (RRC) connected mode of the mobile station. The mobile station may communicate with a base station based at least in part on the information. Numerous other aspects are described.

### FIELD OF THE DISCLOSURE

Aspects of the present disclosure generally relate to wireless communication and to techniques and apparatuses for adaptive reference signal signaling.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a mobile station. The method may include receiving, by the mobile station, reference signal adaptation information or reference signal availability information for a radio resource control (RRC) connected mode of the mobile station. The method may include communicating with a base station based at least in part on the information.

Some aspects described herein relate to a method of wireless communication performed by a base station. The method may include transmitting, to a mobile station, reference signal adaptation information or reference signal availability information for an RRC connected mode of the mobile station. The method may include communicating with the mobile station based at least in part on the information.

Some aspects described herein relate to an apparatus for wireless communication performed by a mobile station. The apparatus may include a memory and one or more processors, coupled to the memory. The one or more processors may be configured to receive reference signal adaptation information or reference signal availability information for an RRC connected mode of the mobile station. The one or more processors may be configured to communicate with a base station based at least in part on the information.

Some aspects described herein relate to an apparatus for wireless communication performed by a base station. The apparatus may include a memory and one or more processors, coupled to the memory. The one or more processors may be configured to transmit, to a mobile station, reference signal adaptation information or reference signal availability information for an RRC connected mode of the mobile station. The one or more processors may be configured to communicate with the mobile station based at least in part on the information.

Some aspects described herein relate to a non-transitory computer-readable medium that stores a set of instructions for wireless communication by a mobile station. The set of instructions, when executed by one or more processors of the mobile station, may cause the mobile station to receive reference signal adaptation information or reference signal availability information for an RRC connected mode of the mobile station. The set of instructions, when executed by one or more processors of the mobile station, may cause the mobile station to communicate with a base station based at least in part on the information.

Some aspects described herein relate to a non-transitory computer-readable medium that stores a set of instructions for wireless communication by a base station. The set of instructions, when executed by one or more processors of the base station, may cause the base station to transmit, to a mobile station, reference signal adaptation information or reference signal availability information for an RRC connected mode of the mobile station. The set of instructions, when executed by one or more processors of the base station, may cause the base station to communicate with the mobile station based at least in part on the information.

Some aspects described herein relate to an apparatus for wireless communication. The apparatus may include means for receiving reference signal adaptation information or reference signal availability information for an RRC connected mode of the apparatus. The apparatus may include means for communicating with a base station based at least in part on the information.

Some aspects described herein relate to an apparatus for wireless communication. The apparatus may include means for transmitting, to a mobile station, reference signal adaptation information or reference signal availability information for an RRC connected mode of the mobile station. The apparatus may include means for communicating with the mobile station based at least in part on the information.

Aspects generally include a method, apparatus, system, computer program product, non-transitory computer-readable medium, user equipment, base station, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of physical channels and reference signals in a wireless network, in accordance with the present disclosure.

FIG. 4 is a diagram illustrating an example of reference signal detection, in accordance with the present disclosure.

FIGS. 5A and 5B are diagrams illustrating an example of reference signal occasions for idle and inactive UEs, in accordance with the present disclosure.

FIG. 6 is a diagram illustrating an example associated with adaptive reference signal signaling, in accordance with the present disclosure.

FIG. 7 is a diagram illustrating an example process associated with adaptive reference signal signaling, in accordance with the present disclosure.

FIG. 8 is a diagram illustrating an example process associated with adaptive reference signal signaling, in accordance with the present disclosure.

FIG. 9 is a diagram of an example apparatus for wireless communication, in accordance with the present disclosure.

FIG. 10 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

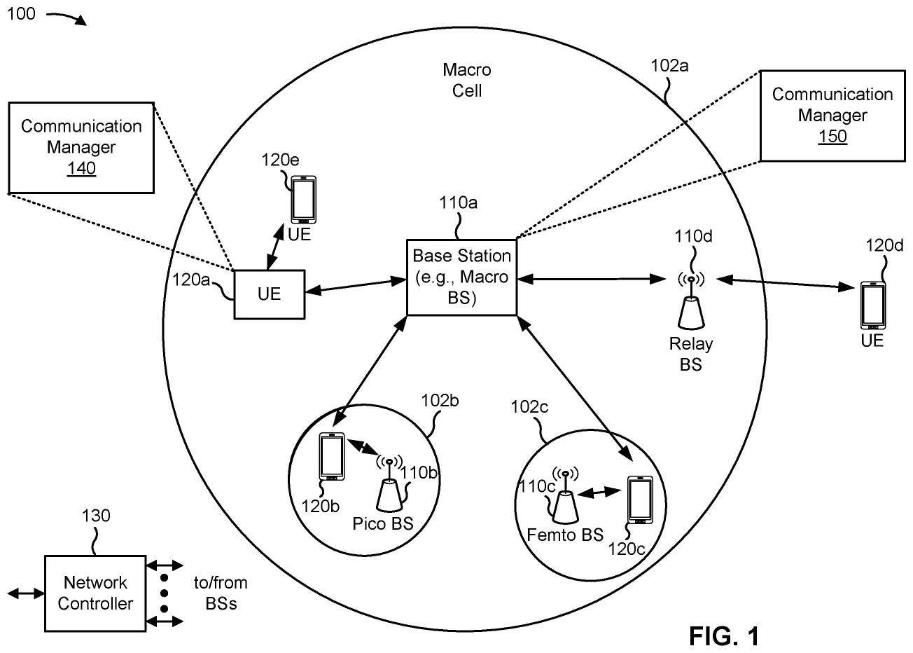

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHz). It should be understood that although a portion of FRI is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHZ), FR4 (52.6 GHz-114.25 GHZ), and FR5 (114.25 GHz-300 GHZ). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR 1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the mobile station may include a communication manager 140. As described in more detail elsewhere herein, the communication manager 140 may receive reference signal adaptation information or reference signal availability information for an RRC connected mode of the mobile station; and communicate with a base station based at least in part on the information. Additionally, or alternatively, the communication manager 140 may perform one or more other operations described herein.

In some aspects, the base station 110 may include a communication manager 150. As described in more detail elsewhere herein, the communication manager 150 may transmit, to a mobile station, reference signal adaptation information or reference signal availability information for an RRC connected mode of the mobile station; and communicate with the mobile station based at least in part on the information. Additionally, or alternatively, the communication manager 150 may perform one or more other operations described herein.

As indicated above, FIG. 1 is provided as an example. Other examples may differ from what is described with regard to FIG. 1.

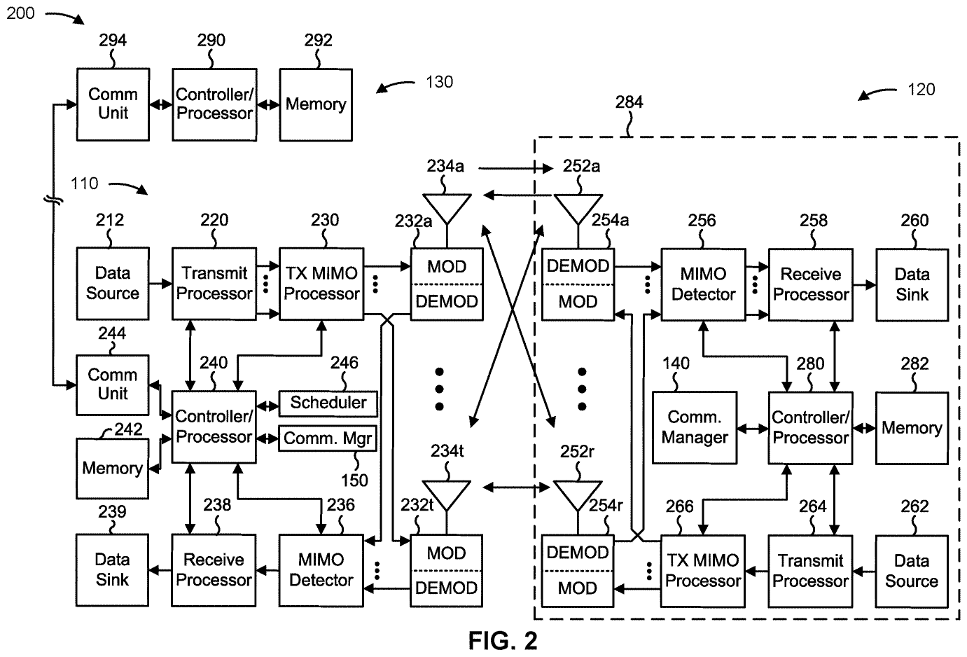

FIG. 2 is a diagram illustrating an example 200 of a base station 110 in communication with a UE 120 in a wireless network 100, in accordance with the present disclosure. The base station 110 may be equipped with a set of antennas 234 a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., Toutput symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

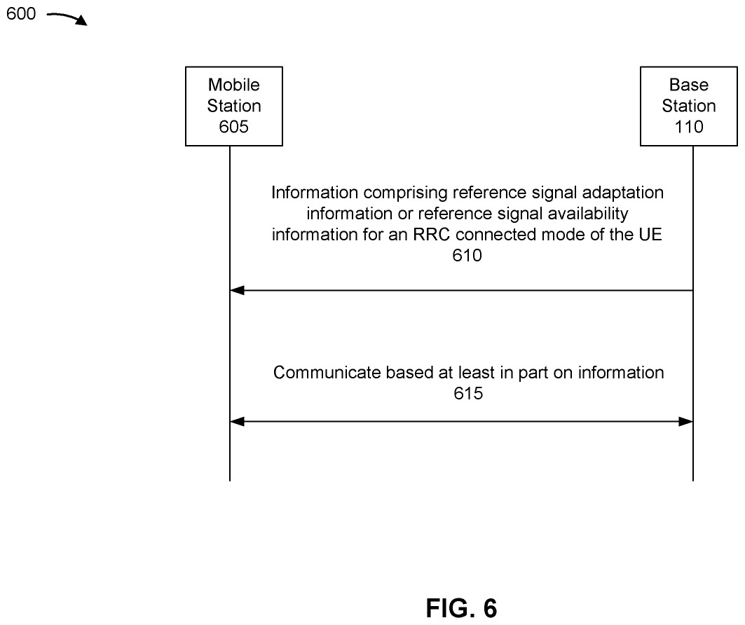

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-10).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-10).

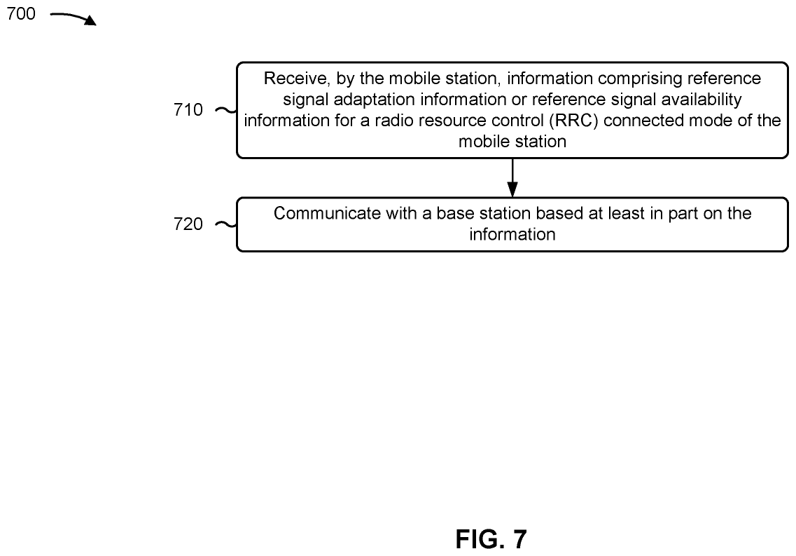

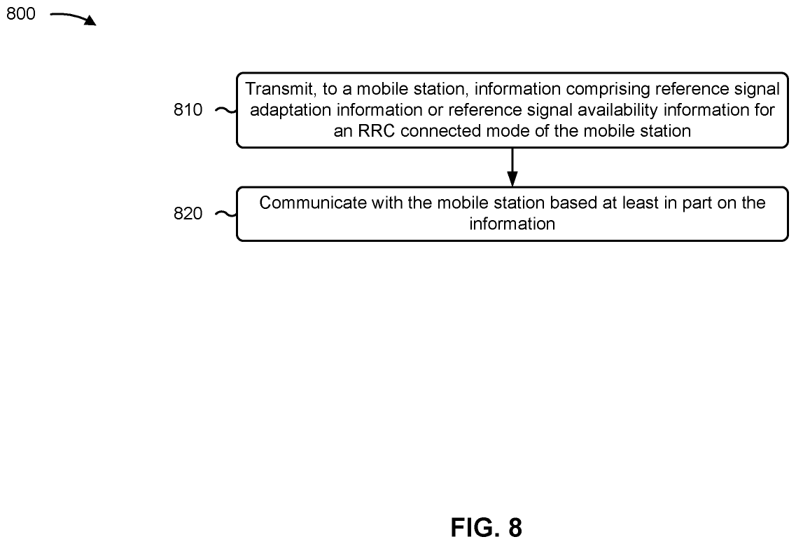

The controller/processor 240 of the base station 110, the controller/processor 280 of the UE 120, and/or any other component(s) of FIG. 2 may perform one or more techniques associated with adaptive reference signal signaling, as described in more detail elsewhere herein. In some aspects, the mobile station described herein is the UE 120, is included in the UE 120, or includes one or more components of the UE 120 shown in FIG. 2. For example, the controller/processor 240 of the base station 110, the controller/processor 280 of the UE 120, and/or any other component(s) of FIG. 2 may perform or direct operations of, for example, process 700 of FIG. 7, process 800 of FIG. 8, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, the mobile station includes means for receiving, by the mobile station, reference signal adaptation information or reference signal availability information for an RRC connected mode of the mobile station; and/or means for communicating with a base station based at least in part on the information. In some aspects, the means for the mobile station to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the base station includes means for transmitting, to a mobile station, reference signal adaptation information or reference signal availability information for an RRC connected mode of the mobile station; and/or means for communicating with the mobile station based at least in part on the information. The means for the base station to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

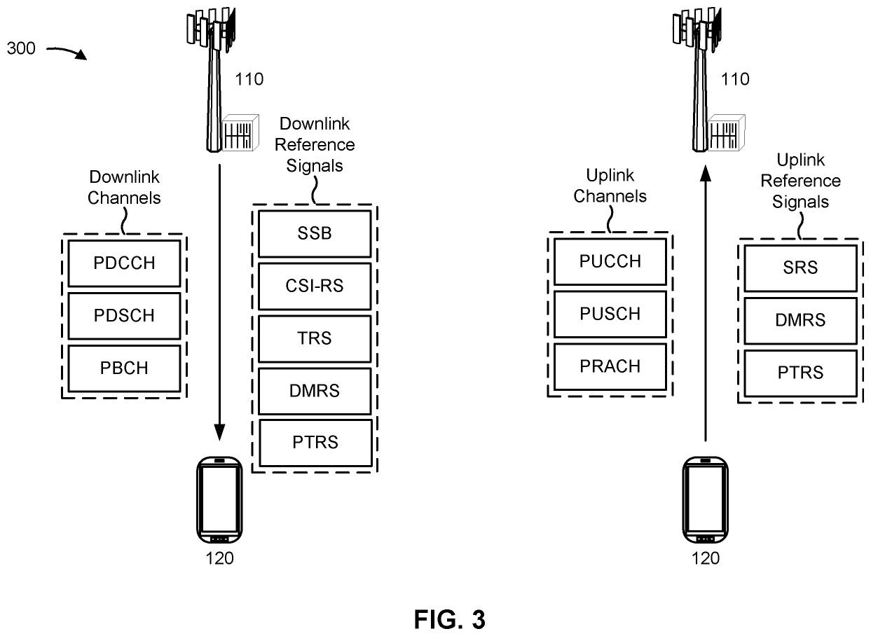

FIG. 3 is a diagram illustrating an example 300 of physical channels and reference signals in a wireless network, in accordance with the present disclosure. As shown in FIG. 3, downlink channels and downlink reference signals may carry information from a base station 110 to a UE 120, and uplink channels and uplink reference signals may carry information from a UE 120 to a base station 110.

As shown, a downlink channel may include a physical downlink control channel (PDCCH) that carries downlink control information (DCI), a physical downlink shared channel (PDSCH) that carries downlink data, or a physical broadcast channel (PBCH) that carries system information, among other examples. In some aspects, PDSCH communications may be scheduled by PDCCH communications. As further shown, an uplink channel may include a physical uplink control channel (PUCCH) that carries uplink control information (UCI), a physical uplink shared channel (PUSCH) that carries uplink data, or a physical random access channel (PRACH) used for initial network access, among other examples. In some aspects, the UE 120 may transmit acknowledgement (ACK) or negative acknowledgement (NACK) feedback (e.g., ACK/NACK feedback or ACK/NACK information) in UCI on the PUCCH and/or the PUSCH.

As further shown, a downlink reference signal may include a synchronization signal block (SSB), a channel state information (CSI) reference signal (CSI-RS), a tracking reference signal (TRS), a demodulation reference signal (DMRS), a positioning reference signal (PRS), or a phase tracking reference signal (PTRS), among other examples. As also shown, an uplink reference signal may include a sounding reference signal (SRS), a DMRS, or a PTRS, among other examples.

An SSB may carry information used for initial network acquisition and synchronization, such as a primary synchronization signal (PSS), a secondary synchronization signal (SSS), a PBCH, and a PBCH DMRS. An SSB is sometimes referred to as a synchronization signal/PBCH (SS/PBCH) block. In some aspects, the base station 110 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The base station 110 may configure a set of CSI-RSs for the UE 120, and the UE 120 may measure the configured set of CSI-RSs. Based at least in part on the measurements, the UE 120 may perform channel estimation and may report channel estimation parameters to the base station 110 (e.g., in a CSI report), such as a channel quality indicator (CQI), a precoding matrix indicator (PMI), a CSI-RS resource indicator (CRI), a layer indicator (LI), a rank indicator (RI), or a reference signal received power (RSRP), among other examples. The base station 110 may use the CSI report to select transmission parameters for downlink communications to the UE 120, such as a number of transmission layers (e.g., a rank), a precoding matrix (e.g., a precoder), a modulation and coding scheme (MCS), or a refined downlink beam (e.g., using a beam refinement procedure or a beam management procedure), among other examples.

A TRS is a reference signal that assists the UE 120 in frequency tracking and time tracking. In some cases, the TRS may be a sparse reference signal (e.g., having a small number of non-zero elements). In some cases, the TRS may be used for downlink transmissions, and may allow the UE 120 to track frequency and time variations with a high resolution. The TRS may allow for fine-tuned synchronization (e.g., as compared to the synchronization reference signals, which allow for coarse synchronization), which may enhance the performance of data transfer in both the uplink and downlink directions. In some cases, the TRS may be similar to the cell-specific reference signal (CRS). However, the TRS may create a lower overhead by occupying a reduced percentage of resource elements, and by using only a single antenna port.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and uplink communications (e.g., on the PUSCH).

A PRS may carry information used to enable timing or ranging measurements of the UE 120 based on signals transmitted by the base station 110 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring base stations in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. In some aspects, the base station 110 may then calculate a position of the UE 120 based on the RSTD measurements reported by the UE 120.

An SRS may carry information used for uplink channel estimation, which may be used for scheduling, link adaptation, precoder selection, or beam management, among other examples. The base station 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The base station 110 may measure the SRSs, may perform channel estimation based at least in part on the measurements, and may use the SRS measurements to configure communications with the UE 120.

Power consumption by cellular networks has resulted in increased carbon emissions and other environmental effects. Additionally, the power consumption of the cellular network may constitute a significant part of the mobile operator's operating expenditure. In some cases, larger bandwidth, and/or a larger number of antennas or bands, may further increase the power consumption by the network. The adaptive RS signaling described herein may be used to reduce network power consumption.

As indicated above, FIG. 3 is provided as an example. Other examples may differ from what is described with regard to FIG. 3.

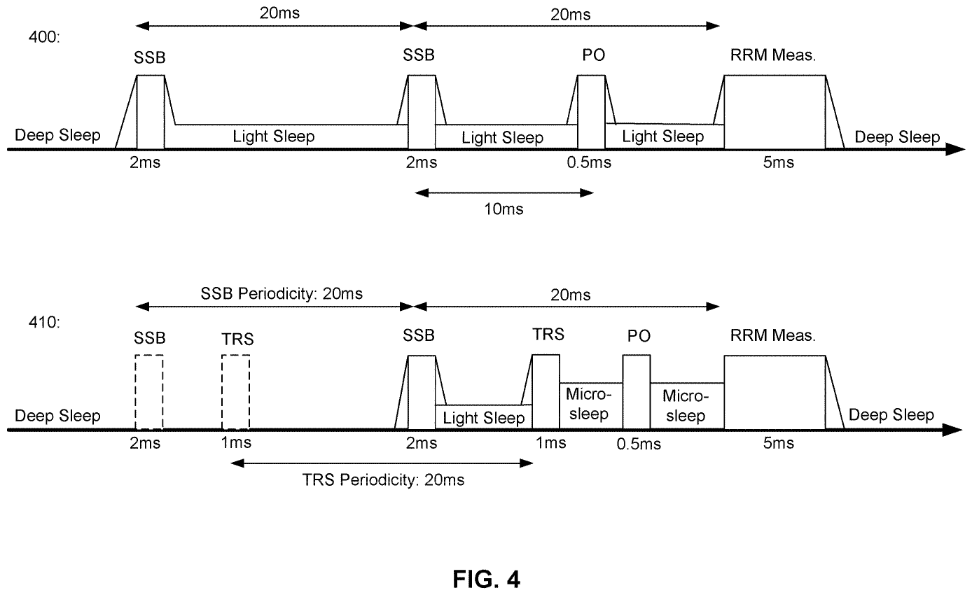

FIG. 4 is a diagram illustrating examples 400 and 410 of reference signal detection, in accordance with the present disclosure. As described above, the TRS may be used for time and frequency tracking during a connected state of the UE 120. Additionally, the TRS and CSI-RS may be used by an idle or inactive UE 120 to refine the time and frequency tracking capabilities of the UE 120. The TRS and CSI-RS may result in power savings, for example, by enabling the UE 120 to reduce the number of SSBs that need to be tracked, and reducing the number of light sleep occasions.

The example 400 shows a first paging procedure in a low signal-to-noise ratio (SNR) scenario, in a bad coverage area (e.g., with poor radio conditions), without using the TRS. As shown, the UE 120 may detect a first SSB, enter a first light sleep mode, detect a second SSB, and enter at least one other light sleep mode, prior to performing radio resource management (RRM). Thus, in low SNR scenarios, the UE 120 may need two SSBs to accomplish the pre-synchronization.

The example 410 shows a second paging procedure in a low SNR scenario, in a bad coverage area (e.g., with poor radio conditions), but with using the TRS. As shown, the UE 120 may detect a first SSB, enter a first light sleep mode, detect the TRS, and enter a micro-sleep mode, prior to performing the RRM. In this case, the nearest SSB and TRS pair may be utilized to perform the synchronization procedure. Thus, the UE 120 (e.g., in an idle mode) may be able to ramp up just before the nearest SSB and TRS, and may use the SSB and TRS to acquire the automatic gain control (AGC) and to perform time and frequency tracking. Thus, the power consumption of one periodicity of light sleep can be saved.

As indicated above, FIG. 4 is provided as an example. Other examples may differ from what is described with regard to FIG. 4.

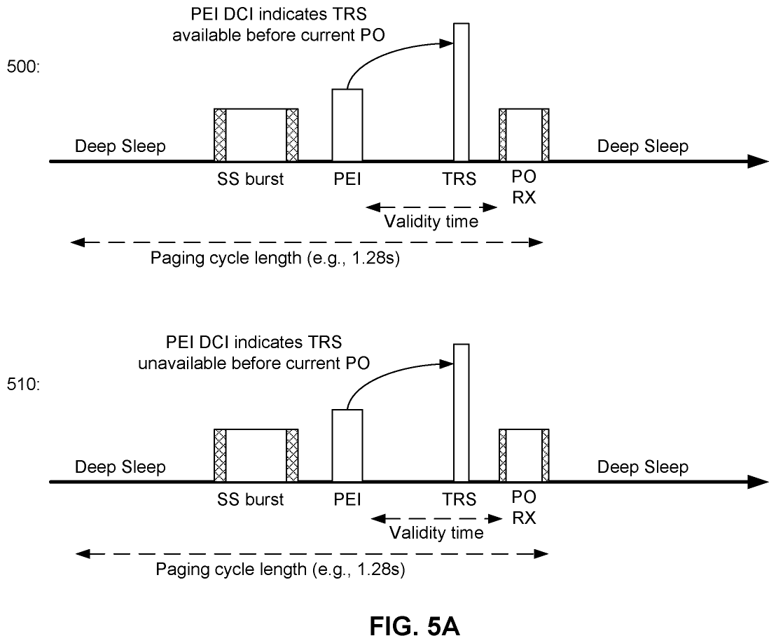

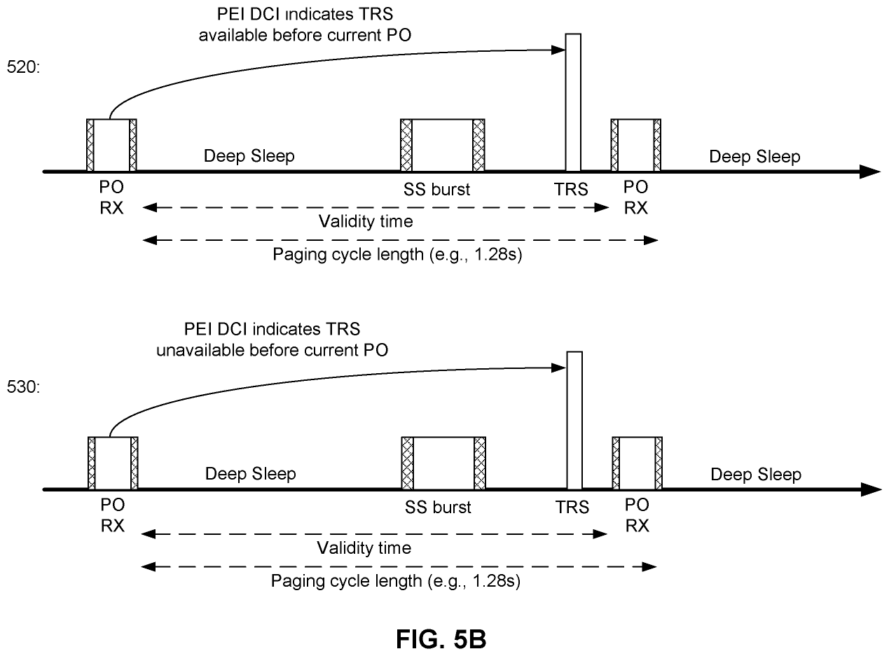

FIGS. 5A and 5B are diagrams illustrating examples 500, 510, 520, and 530 of reference signal occasions for idle and inactive UEs, in accordance with the present disclosure.

In some cases, a paging early indication (PEI) identifier may indicate a TRS availability in an upcoming paging occasion (PO). As shown in example 500, depicted in FIG. 5A, the PEI DCI may indicate that the TRS is available before the current PO. As shown in example 510, the PEI DCI may indicate that the TRS is not available before the current PO. In some cases, if the availability indication is carried by the PEI of the UE 120, the UE 120 may be configured to skip the receiving of the paging DCI and the paging PDSCH (e.g., when there is no paging message for the UE 120). This may result in power savings for the UE 120.

In some cases, the PEI may not be configured. As shown in example 520, depicted in FIG. 5B, the DCI may indicate that the TRS is available before the next PO. As shown in example 530, the DCI may indicate that the TRS is not available before the next PO. In some cases, if the availability indication is only conveyed by the paging DCI, the UE 120 may still need to detect the PO and SSB even when the UE 120 is not paged. This may degrade the power savings gain from the introduction of the PEI.

In some cases, reference signals (e.g., the TRS) may be configured for the UE 120 in the connected mode, and the UE 120 in the idle mode or the inactive mode may be configured to reuse the reference signals from the connected mode. This may restrict the flexibility of the reference signal configuration adaptation, because whether a configured reference signal is actually transmitted may be up to the needs of the connected mode UE 120. For example, the Layer 1(L 1 ) signaling (e.g., paging PDCCH or PEI) may only indicate whether or not the TRS is actually transmitted. This may result in reduced energy saving capabilities of the network and the UE 120. For example, the UE 120 may not be able to use reference signals having a longer periodicity, or a sparser density, in the connected mode of the UE 120.

Techniques and apparatuses are described herein for adaptive RS signaling. In some aspects, the UE 120 may be configured to receive reference signal adaptation information or reference signal availability information for an RRC connected mode of the UE 120. The UE 120 may receive the information via physical layer (e.g., L1) signaling, such as via DCI or a MAC-CE. The UE 120 may communicate with a base station, such as the base station 110, based at least in part on the information.

As described above, the UE 120 (e.g., in the RRC connected mode) may not be configured with reference signal adaptation information, or reference signal availability information. Thus, the use of the reference signals by the connected mode UE 120 may be inflexible, resulting in reduced energy saving capabilities. Using the techniques and apparatuses described herein, the UE 120 may receive reference signal adaptation information, or reference signal availability information, for the RRC connected mode of the UE 120, and may communicate with the base station 110 based at least in part on the information. Using the adaptive reference signaling information, the UE 120 and the network may experience increased energy saving capabilities.

As indicated above, FIGS. 5A and 5B are provided as examples. Other examples may differ from what is described with regard to FIGS. 5A and 5B.

FIG. 6 is a diagram illustrating an example 600 of adaptive RS signaling, in accordance with the present disclosure. A mobile station, such as the mobile station 605, may communicate with a base station, such as the base station 110. In some aspects, the mobile station 605 may be a UE, such as the UE 120.

As shown in connection with reference number 610, the base station 110 may transmit, and the mobile station 605 may receive, reference signal adaptation information or reference signal availability information for a connected state of the mobile station 605, such as an RRC connected mode of the mobile station 605. In some aspects, the reference signal adaptation information may indicate one or more parameters for detecting a reference signal.

The value of the one or more parameters may be different from the semi-static RRC configurations. In some aspects, the reference signal availability information may indicate an availability of the reference signal at a given time.

In some aspects, the information may be the reference signal adaptation information, or may be information that includes the reference signal adaptation information. In some aspects, the information may be the reference signal availability information, or may be information that includes the reference signal availability information. In some aspects, the information may be the reference signal adaptation information and the reference signal availability information, or may be information that includes the reference signal adaptation information and the reference signal availability information.

In some aspects, the information may be transmitted and received via L1 signaling. For example, the base station 110 may transmit, and the mobile station 605 may receive, the DCI or a MAC-CE that includes the reference signal adaptation information and/or the reference signal availability information.

In some aspects, the reference signal may be a TRS. In some aspects, the reference signal may be an SSB. In some aspects, the reference signal may be a CSI-RS. However, the reference signal is not limited to the TRS, SSB, and CSI-RS, and may be any type of reference signal. In some aspects, the reference signal may be a combination of one or more of the reference signals described above.

As described above, the PEI may be used to indicate information (e.g., reference signal adaptation information or reference signal availability information) for the mobile station 605 in the idle or inactive mode. In this case, the radio network temporary identifier (RNTI) used for PEI scrambling may be the paging RNTI.

In some aspects, the information for the mobile station 605 in the connected state (e.g., the RRC connected mode) may be transmitted via DCI. For example, the information may be carried in a PDCCH with a particular DCI format, such as a DCI format that is used (e.g., specifically) for L1 adaptive reference signal signaling.

In some aspects, the DCI may be scrambled using cyclic redundancy check (CRC) scrambling. The CRC of the DCI may be scrambled using an RNTI. In a first example, the CRC may be scrambled by RNTI that is associated with the PEI. In this example, the PDCCH may be distinguished from the PEI based at least in part on the size of the DCI. In a second example, the CRC of the DCI may be scrambled using the paging RNTI (P-RNTI). In this example, the PDCCH may be distinguished, from other PDCCHs using the P-RNTI, based at least in part on the size of the DCI (e.g., paging PDCCH or PEI). In a third example, the CRC of the DCI may be scrambled by an RNTI that is different from the P-RNTI and the RNTI associated with the PEI. For example, the CRC may be scrambled by an RNTI that is used (e.g., specifically) for scrambling the CRC of the DCI having the particular DCI format.

In some aspects, the information may be carried in one or more bits of DCI having an existing DCI format. For example, the information may be carried in one or more bits of DCI format DCI 2_6. In some aspects, one or more bits (e.g., one or more fields) may be added to the DCI 2_6 to indicate the information (e.g., the reference signal adaptation information and/or the reference signal availability information).

In some aspects, the information may be carried in the paging PDCCH. For example, the information may be indicated in one or more reserved bits of the paging PDCCH.

In some aspects, the information may be carried in a MAC message. For example, the information may be transmitted and received via a MAC-CE.

In some aspects, dynamic switching among a plurality of reference signal configurations may be supported. In some aspects, the mobile station 605 may be configured (e.g., RRC configured) with multiple reference signal configurations. Each of the reference signal configurations may indicate a periodicity, a number of symbols, a number of slots, or a frequency density, among other examples, for the reference signal. In some aspects, the mobile station 605 may receive switching information. For example, the mobile station 605 may receive the switching information via DCI or a MAC-CE. The switching information may indicate for the mobile station to switch between the plurality of reference signal configurations. For example, the mobile station 605 may receive DCI that indicates for the mobile station 605 to switch between a first configuration for the TRS and a second configuration for the TRS. In some aspects, a reference signal group (e.g., a “dummy” reference signal group) which contains no reference signals may be used to disable the reference signal monitoring by the mobile station 605.

In some aspects, the mobile station 605 may receive an indication to alter (e.g., change) a configuration for a reference signal. For example, the mobile station 605 may receive an indication (e.g., via DCI or a MAC-CE) that indicates for the mobile station 605 to apply a scaling factor to the reference signal configuration. In some aspects, the scaling factor may be a scaling factor to be applied to the periodicity, the number of symbols, the number of slots, or the frequency density, for the reference signal. For example, the mobile station 605 may receive an indication to apply a scaling factor to the periodicity indication for the reference signal. Thus, the periodicity at which the reference signal is transmitted may be reduced, resulting in energy savings.

As shown in connection with reference number 615, the base station 110 and the mobile station 605 may communicate based at least in part on the information. In some aspects, the mobile station 605 may transmit one or more reference signals, or receive one or more reference signals, based at least in part on the information, such as the reference signal adaptation information and/or the reference signal availability information.

As described above, the mobile station 605 (e.g., in the RRC connected mode) may not be configured with reference signal adaptation information, or reference signal availability information. Thus, the use of the reference signals by the connected mode mobile station 605 may be inflexible, resulting in reduced energy saving capabilities. Using the techniques and apparatuses described herein, the mobile station 605 may receive reference signal adaptation information, or reference signal availability information, for the RRC connected mode of the mobile station 605, and may communicate with the base station 110 based at least in part on the information. Using the adaptive reference signaling information, the mobile station 605 and the network may experience increased energy saving capabilities.

As indicated above, FIG. 6 is provided as an example. Other examples may differ from what is described with regard to FIG. 6.

FIG. 7 is a diagram illustrating an example process 700 performed, for example, by a mobile station, in accordance with the present disclosure. Example process 700 is an example where the mobile station (e.g., mobile station 605) performs operations associated with adaptive reference signal signaling.

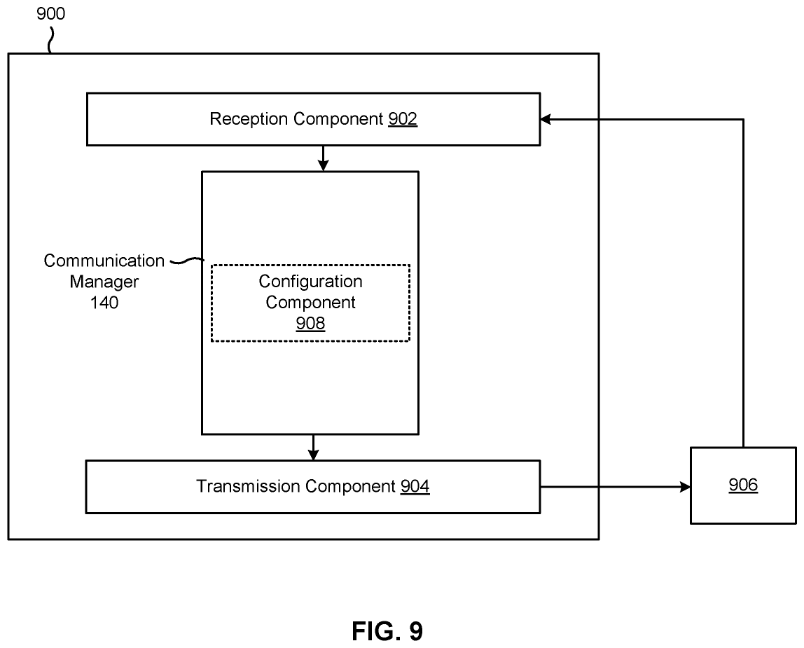

As shown in FIG. 7, in some aspects, process 700 may include receiving reference signal adaptation information or reference signal availability information for an RRC connected mode of the mobile station (block 710). For example, the mobile station (e.g., using communication manager 140 and/or reception component 902, depicted in FIG. 9) may receive reference signal adaptation information or reference signal availability information for an RRC connected mode of the mobile station, as described above.

As further shown in FIG. 7, in some aspects, process 700 may include communicating with a base station based at least in part on the information (block 720). For example, the mobile station (e.g., using communication manager 140, reception component 902 and/or transmission component 904, depicted in FIG. 9) may communicate with a base station based at least in part on the information, as described above.

Process 700 may include additional aspects, such as any single aspect or any combination of aspects described below and/or in connection with one or more other processes described elsewhere herein.

In a first aspect, receiving the information comprises receiving physical layer signaling comprising the information.

In a second aspect, alone or in combination with the first aspect, the information is received via DCI.

In a third aspect, alone or in combination with one or more of the first and second aspects, a cyclic redundancy check of the DCI is scrambled using an RNTI.

In a fourth aspect, alone or in combination with one or more of the first through third aspects, the RNTI is different than a paging RNTI and an RNTI associated with a paging early indication of the mobile station.

In a fifth aspect, alone or in combination with one or more of the first through fourth aspects, the RNTI is an RNTI associated with a paging early indication of the mobile station.

In a sixth aspect, alone or in combination with one or more of the first through fifth aspects, the RNTI is a paging RNTI.

In a seventh aspect, alone or in combination with one or more of the first through sixth aspects, the information is received via one or more additional bits of downlink control information format 2_6.

In an eighth aspect, alone or in combination with one or more of the first through seventh aspects, the information is received via one or more reserved bits of a paging physical downlink control channel.

In a ninth aspect, alone or in combination with one or more of the first through eighth aspects, the information is received via a medium access control message.

In a tenth aspect, alone or in combination with one or more of the first through ninth aspects, the information is associated with a tracking reference signal, a synchronization signal block, or a channel state information reference signal.

In an eleventh aspect, alone or in combination with one or more of the first through tenth aspects, the information further comprises information for dynamically switching between a plurality of reference signal configurations.

In a twelfth aspect, alone or in combination with one or more of the first through eleventh aspects, a reference signal configuration, of the plurality of reference signal configurations, indicates a periodicity, a number of symbols, a number of slots, or a frequency density of a reference signal.

In a thirteenth aspect, alone or in combination with one or more of the first through twelfth aspects, process 700 includes receiving a scaling factor, via downlink control information or a medium access control message, to be applied to the reference signal configuration.

In a fourteenth aspect, alone or in combination with one or more of the first through thirteenth aspects, process 700 includes receiving a dummy reference signal group for disabling a monitoring of the reference signal by the mobile station.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a base station, in accordance with the present disclosure. Example process 800 is an example where the base station (e.g., base station 110) performs operations associated with adaptive reference signal signaling.

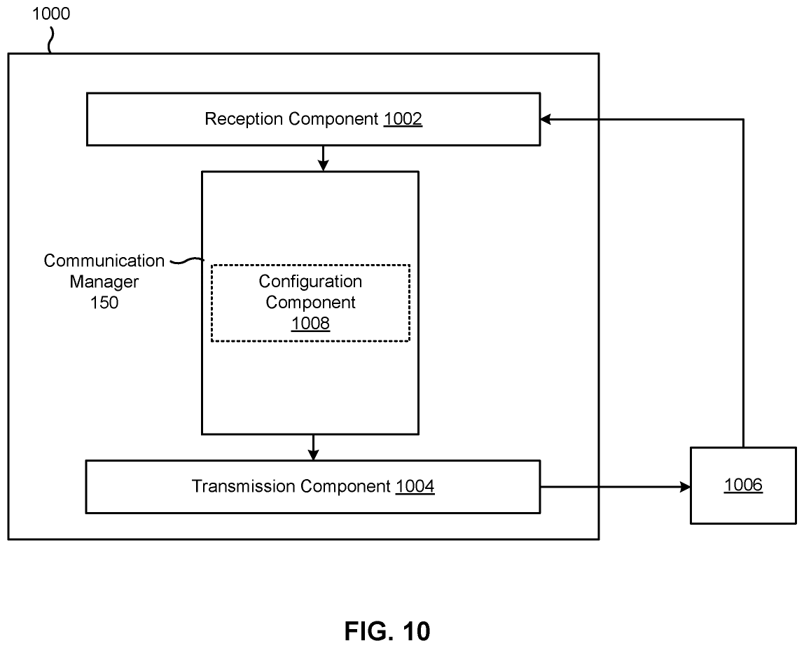

As shown in FIG. 8, in some aspects, process 800 may include transmitting, to a mobile station, reference signal adaptation information or reference signal availability information for an RRC connected mode of the mobile station (block 810). For example, the base station (e.g., using communication manager 150 and/or transmission component 1004, depicted in FIG. 10) may transmit, to a mobile station, reference signal adaptation information or reference signal availability information for an RRC connected mode of the mobile station, as described above.

As further shown in FIG. 8, in some aspects, process 800 may include communicating with the mobile station based at least in part on the information (block 820). For example, the base station (e.g., using communication manager 150, reception component 1002 and/or transmission component 1004, depicted in FIG. 10) may communicate with the mobile station based at least in part on the information, as described above.

Process 800 may include additional aspects, such as any single aspect or any combination of aspects described below and/or in connection with one or more other processes described elsewhere herein.

In a first aspect, transmitting the information comprises transmitting physical layer signaling comprising the information.

In a second aspect, alone or in combination with the first aspect, the information is transmitted via DCI.

In a third aspect, alone or in combination with one or more of the first and second aspects, a cyclic redundancy check of the DCI is scrambled using an RNTI.

In a fourth aspect, alone or in combination with one or more of the first through third aspects, the RNTI is different than a paging RNTI and an RNTI associated with a paging early indication of the mobile station.

In a fifth aspect, alone or in combination with one or more of the first through fourth aspects, the RNTI is an RNTI associated with a paging early indication of the mobile station.

In a sixth aspect, alone or in combination with one or more of the first through fifth aspects, the RNTI is a paging RNTI.

In a seventh aspect, alone or in combination with one or more of the first through sixth aspects, the information is transmitted via one or more additional bits of downlink control information format 2_6.

In an eighth aspect, alone or in combination with one or more of the first through seventh aspects, the information is transmitted via one or more reserved bits of a paging physical downlink control channel.

In a ninth aspect, alone or in combination with one or more of the first through eighth aspects, the information is transmitted via a medium access control message.

In a tenth aspect, alone or in combination with one or more of the first through ninth aspects, the information is associated with a tracking reference signal, a synchronization signal block, or a channel state information reference signal.

In an eleventh aspect, alone or in combination with one or more of the first through tenth aspects, the information further comprises information for dynamically switching between a plurality of reference signal configurations.

In a twelfth aspect, alone or in combination with one or more of the first through eleventh aspects, a reference signal configuration, of the plurality of reference signal configurations, indicates a periodicity, a number of symbols, a number of slots, or a frequency density of a reference signal.

In a thirteenth aspect, alone or in combination with one or more of the first through twelfth aspects, process 800 includes transmitting a scaling factor, via downlink control information or a medium access control message, to be applied to the reference signal configuration.

In a fourteenth aspect, alone or in combination with one or more of the first through thirteenth aspects, process 800 includes transmitting a dummy reference signal group for disabling a monitoring of the reference signal by the mobile station.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication. The apparatus 900 may be a mobile station, or a mobile station may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 140. The communication manager 140 may include a configuration component 908, among other examples.

In some aspects, the apparatus 900 may be configured to perform one or more operations described herein in connection with FIG. 6. Additionally, or alternatively, the apparatus 900 may be configured to perform one or more processes described herein, such as process 700 of FIG. 7. In some aspects, the apparatus 900 and/or one or more components shown in FIG. 9 may include one or more components of the mobile station described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the mobile station described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the mobile station described in connection with FIG. 2. In some aspects, the transmission component 904 may be co-located with the reception component 902 in a transceiver.

The reception component 902 may receive reference signal adaptation information or reference signal availability information for an RRC connected mode of the mobile station. The reception component 902 and/or the transmission component 904 may communicate with a base station based at least in part on the information.

The reception component 902 may receive a scaling factor, via downlink control information or a medium access control message, to be applied to the reference signal configuration.

The reception component 902 may receive a dummy reference signal group for disabling a monitoring of the reference signal by the mobile station.

The configuration component 908 may receive configuration information, such as the reference signal configuration information described above in connection with reference number 610 of the example 600.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components.

Additionally, or alternatively, a set of (one or more) components shown in FIG. 9 may perform one or more functions described as being performed by another set of components shown in FIG. 9.

FIG. 10 is a diagram of an example apparatus 1000 for wireless communication. The apparatus 1000 may be a base station, or a base station may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 150. The communication manager 150 may include a configuration component 1008, among other examples.

In some aspects, the apparatus 1000 may be configured to perform one or more operations described herein in connection with FIG. 6. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the base station described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the base station described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the base station described in connection with FIG. 2. In some aspects, the transmission component 1004 may be co-located with the reception component 1002 in a transceiver.

The transmission component 1004 may transmit, to a mobile station, reference signal adaptation information or reference signal availability information for an RRC connected mode of the mobile station. The reception component 1002 and/or the transmission component 1004 may communicate with the mobile station based at least in part on the information.

The transmission component 1004 may transmit a scaling factor, via downlink control information or a medium access control message, to be applied to the reference signal configuration.

The transmission component 1004 may transmit a dummy reference signal group for disabling a monitoring of the reference signal by the mobile station.

The configuration component 1008 may receive configuration information, such as the reference signal configuration information described above in connection with reference number 610 of the example 600.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:
Aspect 1: A method of wireless communication performed by a mobile station, comprising: receiving, by the mobile station, reference signal adaptation information or reference signal availability information for a radio resource control (RRC) connected mode of the mobile station; and communicating with a base station based at least in part on the information.
Aspect 2: The method of Aspect 1, wherein receiving the information comprises receiving physical layer signaling comprising the information.
Aspect 3: The method of any of Aspects 1-2, wherein the information is received via downlink control information (DCI).
Aspect 4: The method of Aspect 3, wherein a cyclic redundancy check of the DCI is scrambled using a radio network temporary identifier (RNTI).
Aspect 5: The method of Aspect 4, wherein the RNTI is different than a paging RNTI and an RNTI associated with a paging early indication of the mobile station.
Aspect 6: The method of Aspect 4, wherein the RNTI is an RNTI associated with a paging early indication of the mobile station.
Aspect 7: The method of Aspect 4, wherein the RNTI is a paging RNTI.
Aspect 8: The method of Aspect 1, wherein the information is received via one or more additional bits of downlink control information format 2_6.
Aspect 9: The method of any of Aspects 1-8, wherein the information is received via one or more reserved bits of a paging physical downlink control channel.
Aspect 10: The method of Aspect 1, wherein the information is received via a medium access control message.
Aspect 11: The method of any of Aspects 1-10, wherein the information is associated with a tracking reference signal, a synchronization signal block, or a channel state information reference signal.
Aspect 12: The method of any of Aspects 1-11, wherein the information further comprises information for dynamically switching between a plurality of reference signal configurations.
Aspect 13: The method of Aspect 12, wherein a reference signal configuration, of the plurality of reference signal configurations, indicates a periodicity, a number of symbols, a number of slots, or a frequency density of a reference signal.
Aspect 14: The method of Aspect 13, further comprising receiving a scaling factor, via downlink control information or a medium access control message, to be applied to the reference signal configuration.
Aspect 15: The method of Aspect 12, further comprising receiving a dummy reference signal group for disabling a monitoring of the reference signal by the mobile station.
Aspect 16: A method of wireless communication performed by a base station, comprising: transmitting, to a mobile station, reference signal adaptation information or reference signal availability information for a radio resource control (RRC) connected mode of the mobile station; and communicating with the mobile station based at least in part on the information.
Aspect 17: The method of Aspect 16, wherein transmitting the information comprises transmitting physical layer signaling comprising the information.
Aspect 18: The method of any of Aspects 16-17, wherein the information is transmitted via downlink control information (DCI).
Aspect 19: The method of Aspect 18, wherein a cyclic redundancy check of the DCI is scrambled using a radio network temporary identifier (RNTI).
Aspect 20: The method of Aspect 19, wherein the RNTI is different than a paging RNTI and an RNTI associated with a paging early indication of the mobile station.
Aspect 21: The method of Aspect 19, wherein the RNTI is an RNTI associated with a paging early indication of the mobile station.
Aspect 22: The method of Aspect 19, wherein the RNTI is a paging RNTI.
Aspect 23: The method of Aspect 16, wherein the information is transmitted via one or more additional bits of downlink control information format 2_6.
Aspect 24: The method of any of Aspects 16-23, wherein the information is transmitted via one or more reserved bits of a paging physical downlink control channel.
Aspect 25: The method of Aspect 16, wherein the information is transmitted via a medium access control message.
Aspect 26: The method of any of Aspects 16-25, wherein the information is associated with a tracking reference signal, a synchronization signal block, or a channel state information reference signal.
Aspect 27: The method of any of Aspects 16-26, wherein the information further comprises information for dynamically switching between a plurality of reference signal configurations.
Aspect 28: The method of Aspect 27, wherein a reference signal configuration, of the plurality of reference signal configurations, indicates a periodicity, a number of symbols, a number of slots, or a frequency density of a reference signal.
Aspect 29: The method of Aspect 28, further comprising transmitting a scaling factor, via downlink control information or a medium access control message, to be applied to the reference signal configuration.
Aspect 30: The method of Aspect 27, further comprising transmitting a dummy reference signal group for disabling a monitoring of the reference signal by the mobile station.
Aspect 31: An apparatus for wireless communication at a device, comprising a processor; memory coupled with the processor; and instructions stored in the memory and executable by the processor to cause the apparatus to perform the method of one or more of Aspects 1-15.
Aspect 32: A device for wireless communication, comprising a memory and one or more processors, coupled to the memory, configured to, based at least in part on information stored in the memory, perform the method of one or more of Aspects 1-15.
Aspect 33: An apparatus for wireless communication, comprising at least one means for performing the method of one or more of Aspects 1-15.
Aspect 34: A non-transitory computer-readable medium storing code for wireless communication, the code comprising instructions executable by a processor to perform the method of one or more of Aspects 1-15.
Aspect 35: A non-transitory computer-readable medium storing a set of instructions for wireless communication, the set of instructions comprising one or more instructions that, when executed by one or more processors of a device, cause the device to perform the method of one or more of Aspects 1-15.
Aspect 36: An apparatus for wireless communication at a device, comprising a processor; memory coupled with the processor; and instructions stored in the memory and executable by the processor to cause the apparatus to perform the method of one or more of Aspects 16-30.
Aspect 37: A device for wireless communication, comprising a memory and one or more processors, coupled to the memory, configured to, based at least in part on information stored in the memory, perform the method of one or more of Aspects 16-30.
Aspect 38: An apparatus for wireless communication, comprising at least one means for performing the method of one or more of Aspects 16-30.
Aspect 39: A non-transitory computer-readable medium storing code for wireless communication, the code comprising instructions executable by a processor to perform the method of one or more of Aspects 16-30.
Aspect 40: A non-transitory computer-readable medium storing a set of instructions for wireless communication, the set of instructions comprising one or more instructions that, when executed by one or more processors of a device, cause the device to perform the method of one or more of Aspects 16-30.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a mobile station, comprising:
a memory; and
one or more processors, coupled to the memory, configured to, based at least in part on information stored in the memory:
receive reference signal adaptation information or reference signal availability information for a radio resource control (RRC) connected mode of the mobile station; and
communicate with a base station based at least in part on the information.

2. The apparatus of claim 1, wherein the one or more processors, to receive the information, are configured to receive physical layer signaling comprising the information.

3. The apparatus of claim 1, wherein the information is received via downlink control information (DCI).

4. The apparatus of claim 3, wherein a cyclic redundancy check of the DCI is scrambled using a radio network temporary identifier (RNTI).

5. The apparatus of claim 4, wherein the RNTI is different than a paging RNTI and an RNTI associated with a paging early indication of the mobile station.

6. The apparatus of claim 4, wherein the RNTI is an RNTI associated with a paging early indication of the mobile station.

7. The apparatus of claim 4, wherein the RNTI is a paging RNTI.

8. The apparatus of claim 1, wherein the information is received via one or more additional bits of downlink control information format 2_6.

9. The apparatus of claim 1, wherein the information is received via one or more reserved bits of a paging physical downlink control channel.

10. The apparatus of claim 1, wherein the information is received via a medium access control message.

11. The apparatus of claim 1, wherein the information is associated with a tracking reference signal, a synchronization signal block, or a channel state information reference signal.

12. The apparatus of claim 1, wherein the information further comprises information for dynamically switching between a plurality of reference signal configurations.

13. The apparatus of claim 12, wherein a reference signal configuration, of the plurality of reference signal configurations, indicates a periodicity, a number of symbols, a number of slots, or a frequency density of a reference signal.

14. The apparatus of claim 13, wherein the one or more processors are further configured to receive a scaling factor, via downlink control information or a medium access control message, to be applied to the reference signal configuration.

15. An apparatus for wireless communication at a base station, comprising:
a memory; and
one or more processors, coupled to the memory, configured to, based at least in part on information stored in the memory:
transmit, to a mobile station, reference signal adaptation information or reference signal availability information for a radio resource control (RRC) connected mode of the mobile station; and
communicate with the mobile station based at least in part on the information.

16. The apparatus of claim 15, wherein the one or more processors, to transmit the information, are configured to transmit physical layer signaling comprising the information.

17. The apparatus of claim 15, wherein the information is transmitted via downlink control information (DCI).

18. The apparatus of claim 17, wherein a cyclic redundancy check of the DCI is scrambled using a radio network temporary identifier (RNTI).

19. The apparatus of claim 18, wherein the RNTI is different than a paging RNTI and an RNTI associated with a paging early indication of the mobile station.

20. The apparatus of claim 18, wherein the RNTI is an RNTI associated with a paging early indication of the mobile station.

21. The apparatus of claim 18, wherein the RNTI is a paging RNTI.

22. The apparatus of claim 15, wherein the information is transmitted via one or more additional bits of downlink control information format 2_6.

23. The apparatus of claim 15, wherein the information is transmitted via one or more reserved bits of a paging physical downlink control channel.

24. The apparatus of claim 15, wherein the information is transmitted via a medium access control message.

25. The apparatus of claim 15, wherein the information is associated with a tracking reference signal, a synchronization signal block, or a channel state information reference signal.

26. The apparatus of claim 15, wherein the information further comprises information for dynamically switching between a plurality of reference signal configurations.

27. The apparatus of claim 26, wherein a reference signal configuration, of the plurality of reference signal configurations, indicates a periodicity, a number of symbols, a number of slots, or a frequency density of a reference signal.

28. The apparatus of claim 27, wherein the one or more processors are further configured to transmit a scaling factor, via downlink control information or a medium access control message, to be applied to the reference signal configuration.

29. A method of wireless communication performed by a mobile station, comprising:
receiving, by the mobile station, reference signal adaptation information or reference signal availability information for a radio resource control (RRC) connected mode of the mobile station; and
communicating with a base station based at least in part on the information.

30. The method of claim 29, wherein the information is received via downlink control information (DCI).

31. The method of claim 29, wherein the information is received via one or more additional bits of downlink control information format 2_6.

32. The method of claim 29, wherein the information is received via a medium access control message.

33. A method of wireless communication performed by a base station, comprising:
transmitting, to a mobile station, reference signal adaptation information or reference signal availability information for a radio resource control (RRC) connected mode of the mobile station; and
communicating with the mobile station based at least in part on the information.

34. The method of claim 33, wherein the information is transmitted via downlink control information (DCI).

35. The method of claim 33, wherein the information is transmitted via a medium access control message.
